(19) United States
(12) Patent Application Publication
(10) Pub. No.: US 2021/0283754 A1
(43) Pub. Date: Sep. 16, 2021

(54) Tool for Opening Underground Power Transformers

(71) Applicant: David Daniel Conyers, Murrells Inlet, SC (US)

(72) Inventor: David Daniel Conyers, Murrells Inlet, SC (US)

(21) Appl. No.: 16/818,420

(22) Filed: Mar. 13, 2020

(51) Int. Cl. B25B 25/00; H02B 1/38; B25G 1/04

(52) U.S. Cl. CPC B25B 25/00; B25G 1/04; H02B 1/38

(57) ABSTRACT

The present invention is a tool designed for opening the electrical transformer boxes used for underground power line installations from a position of safety for the person who needs to open the box to make repairs. The tool consists of a long telescoping handle on top of which is a partially enclosed roller and a strap positioned over the roller. At one end of the strap is a hook to connect to the latch on the electrical transformer box and at the other end of the strap is a hand grip for the user. The user pulls on the strap, which in turns goes taut and opens the electrical transformer box. The long handle is telescoping to make the tool easer to transport and store.

### CROSS REFERENCE TO RELATED APPLICATIONS

Not Applicable

### STATEMENT REGARDING FEDERALLY SPONSORED RESEARCH OR DEVELOPMENT

This invention was not made by an agency of the United States Government nor under a contract with an agency of the United States Government.

### THE NAME OF THE PARTIES TO JOINT RESEARCH AGREEMENT

Not Applicable.

### INCORPORATION BY REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable

### BACKGROUND OF THE INVENTION

### Field of the Invention

Buried power lines are becoming increasingly popular versus the standard pole installation power lines. Buried lines maintain a more aesthetically pleasing environment. Additionally, they reduce electrical outages because the buried lines are not susceptible to damage from high winds or falling trees during storms.

Underground power transformer boxes are used to enclose the electrical transformers for buried power lines. The boxes themselves are not typically underground themselves. Servicing the equipment in the boxes presents some safety issues when opening the boxes to access the equipment, notably unknown danger from damaged equipment and the presence of snakes.

The present invention provides a way for the person opening the underground electrical transformer box to do so from a position relative to the box where the person would not be in the path of electrical discharge from damaged equipment or the range of a striking snake.

### Description of Related Art

U.S. Published Patent Application 2013/0234458 for a Zipper Pulling Tool is a device with a telescoping handle to grasp the pull tab of a zipper for opening or closing a zipper. Like the present invention has a telescoping section that is secured into position with locking pins. The function is quite different from the present invention.

### BRIEF SUMMARY OF THE INVENTION

The present invention is a tool designed for opening the electrical transformer boxes used for underground power line installations from a position of safety for the person who needs to open the box to make repairs. The invention allows the user to stand behind the electrical transformer box to open the box so that the user is not in the path of any electrical discharge from damaged equipment or in the path of a striking snake that may be in the box.

The tool consists of a long telescoping handle on top of which is a partially enclosed roller and a strap positioned over the roller. At one end of the strap is a hook to connect to the latch on the electrical transformer box and at the other end of the strap is a hand grip for the user. The user pulls on the strap, which in turns goes taut and opens the electrical transformer box. The long handle is telescoping to make the tool easer to transport and store.

### BRIEF DESCRIPTION OF THE SEVERAL VIEWS OF THE DRAWING

FIG. 1 is a view showing the tool being used to open an electrical transformer box for buried power lines.

FIG. 2 is a view of the tool in the extended position showing both section of the telescoping handle (10, 15), the head section (20) which encloses the roller (30) and the pull strap (40).

FIG. 3 is a view of the head section (20) of the tool displaying the roller (30) and the pull strap (40).

FIG. 4 is a view of the head section (20) and the pull strap (40).

### DETAILED DESCRIPTION OF THE INVENTION

The present invention is a tool designed for opening the electrical transformer boxes used for underground power line installations. The tool allows the user to stand behind the box while opening the box so that the user is not in the path of any electrical discharge from damaged equipment. As snakes are known to frequently inhabit these boxes, use of the tool also allows the repair person to open the box and not be subject to a bite from a potentially venomous snake residing in the transformer box.

The tool consists of a long telescoping handle (10, 15) on top of which is a partially enclosed roller (30) and a strap (40) positioned over the roller. At one end of the strap is a hook to connect to the latch on the electrical transformer box and at the other end of the strap is a hand grip for the user. The user pulls on the strap, which in turns goes taut and opens the electrical transformer box. The long handle is telescoping to make the tool easer to transport and store.

The telescoping handle is in two sections (10, 15) with an overall extended length of 60 to 80 inches with a nominal length of 70 inches. Each section (10, 15) is constructed from fiberglass tubing with the base section (15) being slightly larger than the upper section (10). In the preferred embodiment of the invention, the base section (15) is constructed of square 2 inch fiberglass tubing with the upper section (10) constructed from square 1½ inch fiberglass tubing.

Holes are drilled at the top portion of the base section (15) and the bottom portion of the upper section (10) to allow the sections to be secured in the extended position utilizing a locking pin (12). When extended the overall length of the two sections (10, 15) is approximately 70 inches. When not extended, the overall length of the tool is between 30 and 45 inches with a typical length of 40 inches.

Although the preferred embodiment of the invention utilizes 1½ and 2 inch square fiberglass tubing, it should be noted that the invention is not limited to those particular sizes and shapes of fiberglass tubing. Other sizes and shapes can be utilized.

The top cap (20) is positioned at the opposite end of the upper section (10) from the base section. The top cap is constructed of aluminum and houses the roller (30) and the pull strap (40). The top cap (20) is affixed to the upper section (10) of the handle utilizing a locking pin (21). However, securing the top cap (20) to the upper section (10) is not limited to a locking pin as the top cap (20) could be affixed to the upper section (10) using a nut and bolt combination or an adhesive.

The top cap contains a roller (30) for movement of the pull strap (40). The roller (30) is affixed within the top cap (20) utilizing a locking pin (31).

In the preferred embodiment of the invention, the top cap (20) and roller (30) are constructed of aluminum. However, the construction of both the top cap (20) and roller (30) could be constructed of various other materials, including but not limited to, fiberglass, PVC, stainless steel or high density polyethylene (HDPE).

Locking pins are utilized in the preferred embodiment to attach the various pieces of the invention to each other. Other means of attachment could be utilized, including but not limited to nut and bolt combination and adhesives.

Although the drawings and the above description represent the preferred embodiment of the invention, it should be recognized that the invention is not limited to the exact configuration and sizes described above.

Potential CPC Patent Classification for this Invention:
B66 D 3/00: Portable or mobile lifting or hauling appliances.

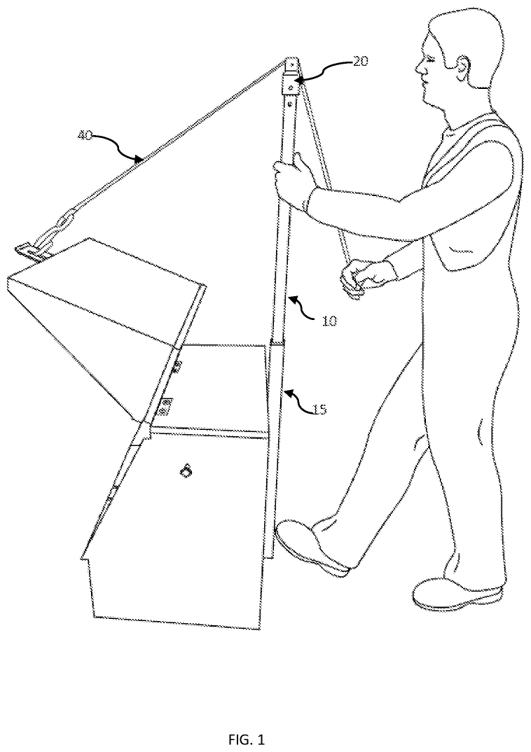

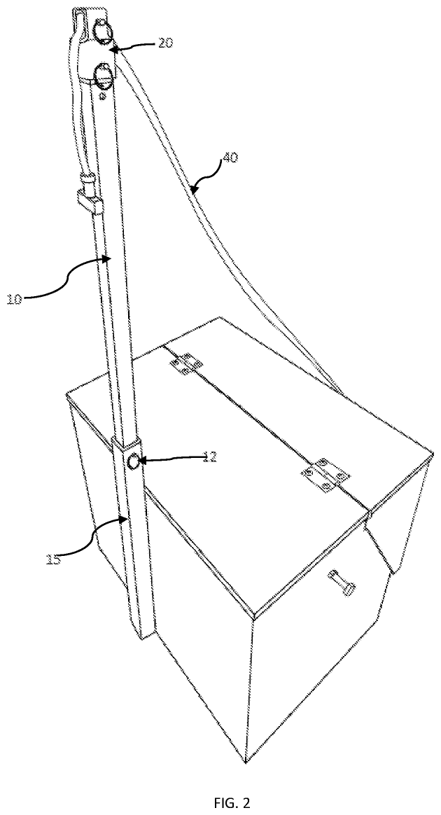

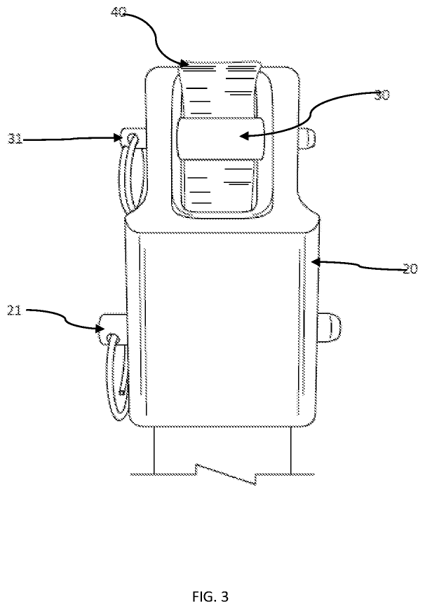

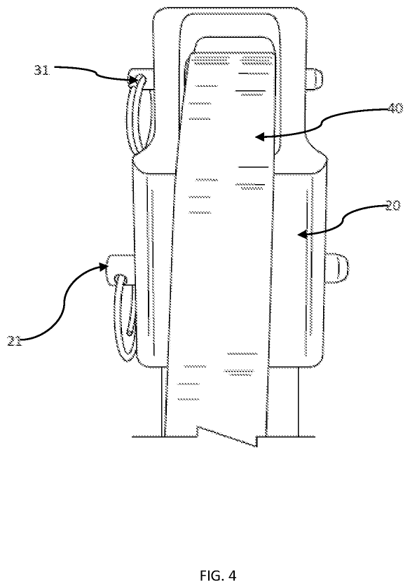

The present invention described above and illustrated in FIGS. 1 through 4 is visualized as the preferred embodiment of the invention. It is envisioned that this invention may be embodied in many different forms and should not be construed as limited to the embodiments set forth herein. It will be understood by those skilled in the art that changes in forms and details may be made without departing from the spirit and scope of the present application. It is therefore intended that the present invention is not limited to the exact forms and details described and illustrated herein but falls within the scope of the appended claims.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a stricture or feature that is disposed “adjacent” another feature may have portions that overlap or underlie the adjacent feature.

The invention claimed is:

1. A tool for opening the electrical transformer boxes associated with underground power line installations where said tool allows the user to open said electrical transformer box from a position of safety behind said electrical transformer box where said tool is comprised of a telescoping handle, a top cap containing a roller and a pull strap where said handle is constructed from fiberglass tubing and said top cap and roller are constructed from aluminum.

2. The tool of claim 1, where said telescoping handle is 60 to 80 inches in length when extended and 30 to 45 inches when not extended.

3. The tool of claim 1, where said top cap and roller are constructed from fiberglass, PVC, stainless steel or high density polyethylene.

4. A system for opening the electrical transformer boxes for underground power line installations consisting of a tool that allows the user to open said electrical transformer box from a position of safety behind said electrical transformer box where said tool is comprised of a telescoping handle, a top cap containing a roller and a pull strap where said handle is constructed from fiberglass tubing and said top cap and roller are constructed from aluminum.

5. The tool of claim 4, where said telescoping handle is 60 to 80 inches in length when extended and 30 to 45 inches when not extended.

6. The tool of claim 4, where said top cap and roller are constructed from fiberglass, PVC, stainless steel or high density polyethylene.
